(19) United States
(12) Patent Application Publication
(10) Pub. No.: US 2025/0222625 A1
(43) Pub. Date: Jul. 10, 2025

(54) MANUALLY ACTUATED CERAMIC CUTTER

(71) Applicant: GERMANS BOADA, S.A., Rubi (ES)

(72) Inventor: David MARTINEZ GALINDO, Rubi (ES)

(21) Appl. No.: 19/093,643

(22) Filed: Mar. 28, 2025

Related U.S. Application Data
(63) Continuation of application No. PCT/ES2022/070755, filed on Nov. 23, 2022.

(51) Int. Cl. B28D 1/22; B28D 7/04

(52) U.S. Cl. CPC B28D 1/225; B28D 7/04

(57) ABSTRACT

A manually actuated ceramic cutter includes a work table mounted on a support structure, and a tool-carrier head provided with a cutting tool and with an actuating handle, which tool-carrier head can be moved along longitudinal guide means comprising a single longitudinal guide disposed on one side of the tool-carrier head, the guide being offset from a vertical plane coinciding with the longitudinal path of the cutting tool during the scoring of the ceramic pieces and being attached by the ends thereof to respective sides of supports attached at opposite ends of the support structure. The longitudinal guide includes longitudinal tracks for moving a sliding piece, the side of which piece is provided with a horizontal shaft for rotating the tool-carrier head in a vertical plane.

### CROSS-REFERENCE TO RELATED APPLICATIONS

This application is a continuation of International Application No. PCT/ES2022/070755, filed on Nov. 23, 2022, the entire disclosure of which is hereby incorporated herein by reference.

### TECHNICAL FIELD

The present invention belongs to the field of manually actuated machines and more specifically manually actuated ceramic cutters used to score a cutting line on ceramic pieces and break said ceramic pieces along the aforementioned cutting line.

### BACKGROUND

Nowadays, manual ceramic cutters are widely known on the market, said cutters comprising a work table suitable for positioning the ceramic piece to be cut, and a tool-carrier head provided with a cutting tool, which is manually actuated by a handle and which moves longitudinally along guide means to score a cutting line on the ceramic piece with said cutting tool.

With regard to the guide means of the tool-carrier head, there are basically two types of manual ceramic cutters, namely cutters with two parallel guides on which a tool-carrier head moves between the two guides, and cutters with a single central guide on which the tool-carrier head moves longitudinally, the latter type of cutter being the most closely related to the one that is the subject matter of the present invention.

Some examples of manual ceramic cutters provided with a single guide for moving the tool-carrier head, also known as monoguide cutters, are described in utility models ES1067012U, ES1062584U and ES1069449U, all of which are from the same applicant of the present invention.

These monoguide cutters have a number of drawbacks, which are mentioned below.

A first drawback is that they have a small cutting tool which is inserted in the lower portion of the tool-carrier head, so that, compared to two-guide cutters, said cutting tool has very little play, as it is practically a fixed element with no mobility. This is due to the fact that there is very little space between the mounting area of the cutting tool on the tool-carrier head and the ceramic piece to be cut and, consequently, the vertical movement of said cutting head is also very small.

Another drawback of these monoguide cutters is the difficulty for the operator to see the cutting area, as the cutting tool is hidden underneath the tool-carrier head and is vertically aligned with the guide for moving said head.

An additional drawback is that the cutting power that can be applied is very limited.

When the tool-carrier head moves along the longitudinal guide by friction, i.e., without any elements providing smooth movement, sudden and intermittent movements of the tool-carrier head occur, resulting in irregular scoring of the cutting line on the ceramic pieces and subsequent irregular cutting or breaking of the ceramic piece along said cutting line.

The technical problem addressed is the development of a manual ceramic cutter, of the monoguide type, which facilitates its use by the operator and the quality of the cut obtained.

### SUMMARY

The manually actuated ceramic cutter of the present invention has technical features that improve the operator's view of the cutting area and provide a smooth and straight movement of the head, ensuring correct scoring of the cutting line on the ceramic piece.

This cutter is of the type described in the preamble of the main claim and comprises: a work table mounted on a support structure, a tool-carrier head movable along the longitudinal guide means and comprising a cutting tool for scoring a breakage line on the ceramic pieces, an actuating handle and a blank holder for breaking the ceramic piece along the cutting line previously scored on the ceramic piece with the cutting tool.

According to the invention, the longitudinal guide means of the tool-carrier head comprise a single longitudinal guide disposed on one side of the tool-carrier head, the guide being offset laterally from a vertical plane coinciding with the longitudinal path of the cutting tool during the scoring of the ceramic pieces, and being attached by the ends thereof to supports attached in turn at opposite ends of the support structure.

The guiding of the tool-carrier head on a single longitudinal guide, the guide being moved laterally relative to said tool-carrier head, in addition to providing greater simplicity with respect to manual ceramic cutters provided with two parallel guides, substantially improves the operator's view of the cutting area as said guide does not constitute a hindrance to viewing the work area.

According to the invention, the aforementioned longitudinal guide comprises at least one track or rail for moving a sliding piece, the side of which piece is provided with a horizontal shaft for rotating the tool-carrier head in a vertical plane.

This horizontal shaft, in addition to allowing the tool-carrier head to rotate in a vertical plane in order to move the cutting tool closer to or further away from the ceramic piece to be cut, provides a lateral offset between the tool-carrier head and said longitudinal guide and the path of the cutting tool, helping to prevent the longitudinal guide from interfering with the view of the cutting area.

According to the invention, the support structure is vertically aligned with the longitudinal median plane of the work table and with the longitudinal path of the cutting tool, said support structure comprising at least one longitudinal profile arranged below said work table.

In the invention, it is envisaged that the longitudinal guide may comprise a first longitudinal track and a second longitudinal track along which rolling elements move, which are connected to the sliding piece by means of respective rotating shafts and which limit the possibility of movement of said sliding piece to only the longitudinal direction.

These rolling elements, in addition to limiting the movement of the sliding piece to the longitudinal direction, which ensures that the cutting tool scores a straight and precise cutting line on the ceramic piece, provide smooth movement of the tool-carrier head with respect to said single longitudinal guide, avoiding jams and irregular movements of the tool-carrier head that usually occur in monoguide cutters.

An additional feature of said guide, aimed at preventing the accumulation of dirt on the longitudinal tracks of the guide, which could hinder smooth and regular movement of the tool-carrier head, is that the first track is defined on a lateral face of the longitudinal guide facing the tool-carrier head and the second track is defined on a lower face of said longitudinal guide. This lateral and lower arrangement of the tracks in the longitudinal guide makes it difficult for dust, dirt or particles from building materials to enter the tracks.

According to the invention, the sliding piece comprises a vertical flange, arranged between the longitudinal guide and the tool-carrier head, and a horizontal flange arranged between the lower face of the longitudinal guide and the work table; so that the rotating shafts of the rolling elements that move along the first track of the longitudinal guide and the horizontal shaft for vertically rotating the tool-carrier head are mounted on the vertical flange of the sliding piece, while the rotating shafts of the rolling elements the move along the second track of the longitudinal guide are mounted on the horizontal flange of the sliding piece.

### BRIEF DESCRIPTION OF THE DRAWINGS

As a complement to the description provided herein, and for the purpose of helping to make the features of the invention more readily understandable, the present specification is accompanied by a set of drawings which, by way of illustration and not limitation, represent the following:

FIG. 1 shows a top perspective view of an exemplary embodiment of the manually actuated ceramic cutter according to the invention.

FIG. 2 shows a bottom perspective view of the ceramic cutter of the previous figure.

FIGS. 3 and 4 show an elevation view and a top plan view, respectively, of the ceramic cutter of the previous figures.

FIG. 5 shows an enlarged perspective view of one of the ends of the ceramic cutter.

FIG. 6 shows a partial profile view of the cutter sectioned along a vertical plane, showing the sectioned longitudinal guide and the rolling means of the sliding piece that supports the tool-carrier head.

### DETAILED DESCRIPTION

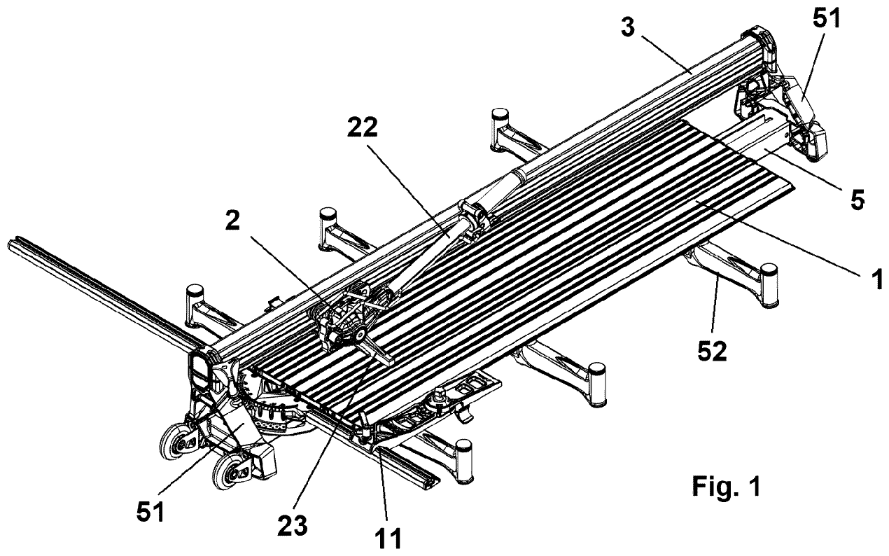

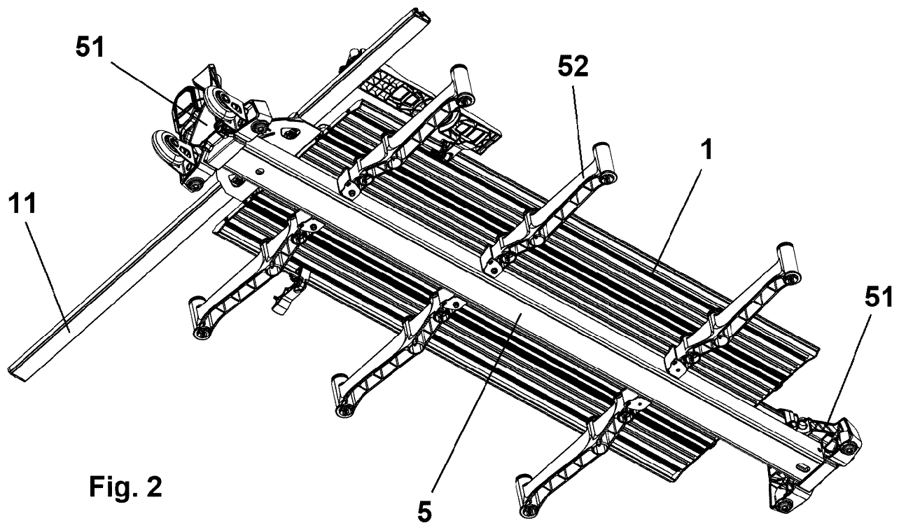

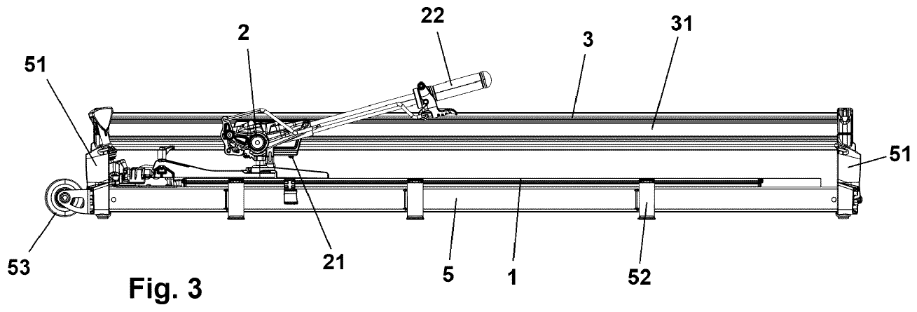

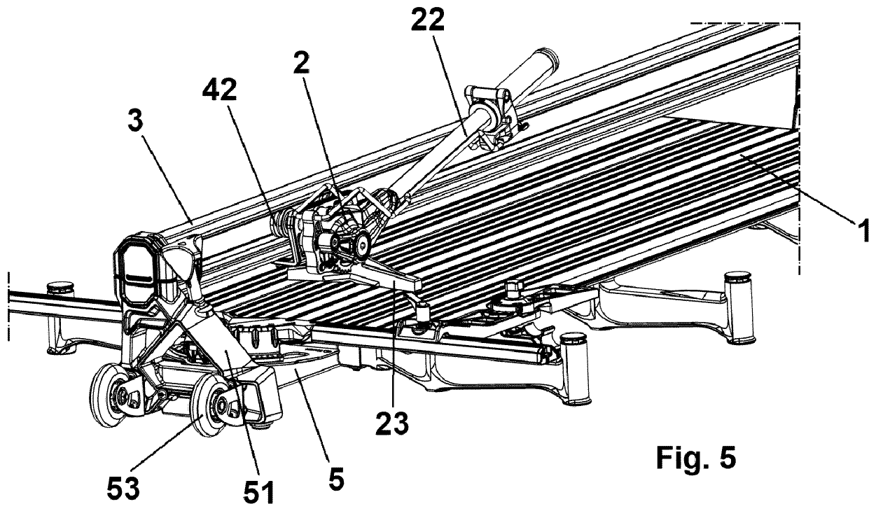

The manually actuated ceramic cutter shown in the exemplary embodiment in FIGS. 1 to 6 comprises a work table (1) for supporting the ceramic pieces to be cut and which has an adjustable set square (11) at one of its ends.

Said cutter comprises, above the work table (1), a tool-carrier head (2) provided with a cutting tool (21) for scoring a cutting line on the ceramic pieces, an actuating handle (22) of the tool-carrier head and a blank holder (23) for breaking the ceramic piece along the cutting line previously scored by the cutting tool (21).

This cutter comprises, for moving the tool-carrier head (2), a single longitudinal guide (3) disposed on one side of the tool-carrier head and moved towards one side of the work table (1), said tool-carrier head (2) being mounted on a sliding piece (4) movable along said longitudinal guide (3) by means of rolling elements.

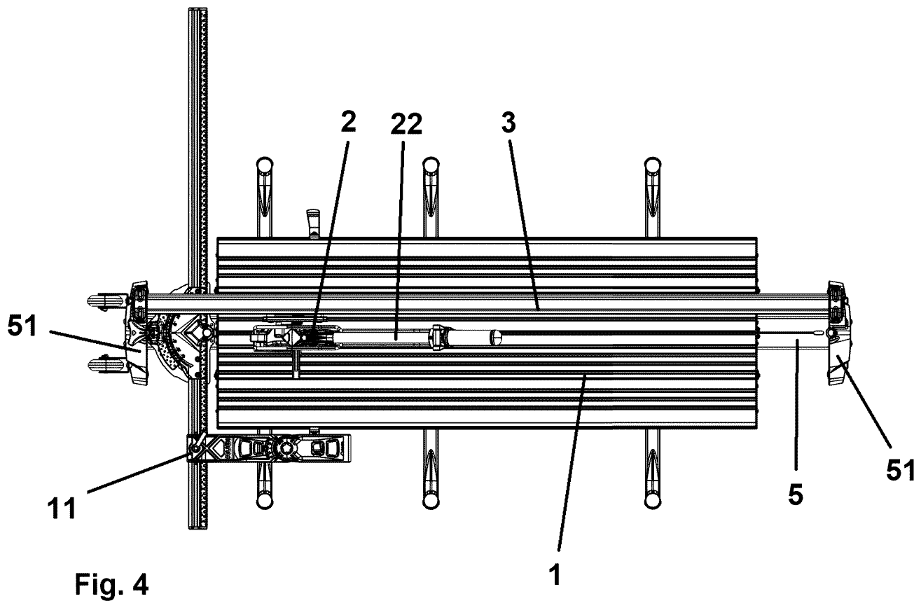

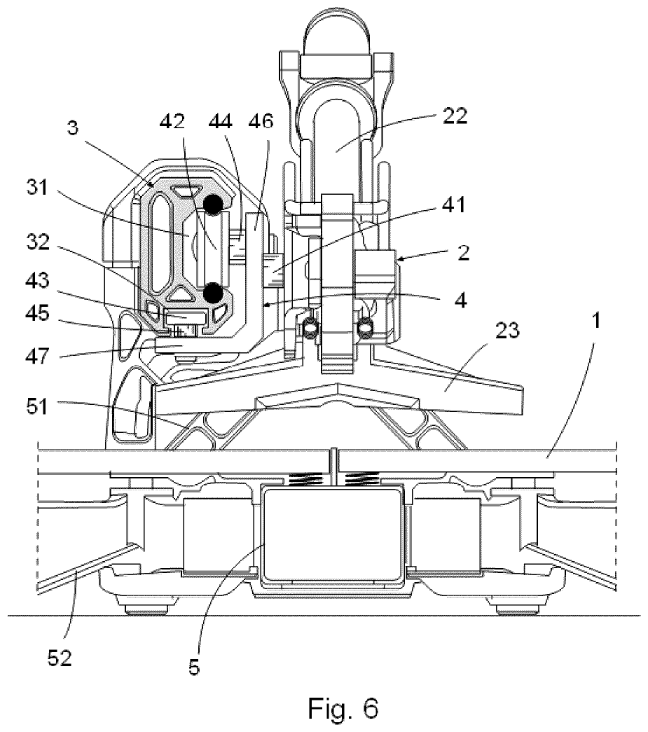

As shown in greater detail in FIGS. 4 and 6, the arrangement of the longitudinal guide (3), moved towards one of the sides of the work table (1), means that said longitudinal guide does not constitute a hindrance to the operator's view of the cutting area.

The longitudinal guide (3) is mounted by the ends thereof on one side of supports (51) attached on the support structure (5) which, in this exemplary embodiment, is made up of a single longitudinal profile arranged below the work table (1) and vertically aligned with the tool-carrier head (2). This support structure (5) has arms (52) on its sides for the oscillating support of two halves of the work table (1) arranged on opposite sides of the longitudinal path of the cutting tool (21).

One of the supports (51) attached at the ends of the support structure (5) has wheels (53) to facilitate the transport of the ceramic cutter by holding it at the opposite end.

As shown in FIG. 6, the longitudinal guide (3) comprises a first longitudinal track (31) defined on the lateral face of the longitudinal guide facing the tool-carrier head (2) and a second longitudinal track (32) defined on the lower face of the aforementioned longitudinal guide (3).

In the first track (31) there are at least three vertical rolling elements (42) with the possibility of longitudinal movement, offset from each other in the longitudinal direction and which act on the opposite ends, upper and lower, of the first track (31) and which are attached by means of the corresponding rotating shafts (44) to the sliding piece (4), preventing it from moving in the vertical direction.

In the second track (32) of the longitudinal guide, there are at least two horizontal rolling elements (43) which act on opposite sides of said second track (32) and which are attached by means of respective rotating shafts (45) to the sliding piece (4), preventing it from moving in the lateral direction.

The tool-carrier head (2) is mounted on a horizontal shaft (41) that starts laterally from the sliding piece (4) and that allows its vertical rotation to vertically move the cutting tool (21) closer to or further away from the ceramic piece to be cut.

In the example shown in FIG. 6, the sliding piece (4) has an L-shaped section that comprises a vertical flange (46) on which the rotating shafts (44) of the vertical rolling elements (42) and the horizontal shaft (41) for rotating the tool-carrier head (2) are mounted; and a horizontal flange (47) on which the rotating shafts (45) of the horizontal rolling elements (43) are mounted.

Said rolling means (42, 43) provide smooth and exclusively longitudinal movement of the sliding piece (4) and the tool-carrier head (2), which guarantees high precision in the definition of the cutting line of the ceramic pieces by means of the cutting tool.

Having sufficiently described the nature of the invention, in addition to a preferred exemplary embodiment, it is hereby stated for the relevant purposes that the materials, shape, size and layout of the described elements may be modified, provided that it does not imply altering the essential features of the invention claimed below.

What is claimed is:

1. A manually actuated ceramic cutter comprising:
a work table mounted on a support structure; and
a tool-carrier head movable along longitudinal guide means and provided with a cutting tool and with an actuating handle;
wherein the longitudinal guide means of the tool-carrier head comprises a single longitudinal guide disposed on one side of the tool-carrier head, the guide being offset from a vertical plane coinciding with a longitudinal path of the cutting tool during scoring of ceramic pieces and being attached by the ends thereof to respective sides of supports attached at opposite ends of the support structure; and
wherein the longitudinal guide comprises at least one longitudinal track for moving a sliding piece, and a side of the sliding piece is provided with a horizontal shaft for rotating the tool-carrier head in the vertical plane.

2. The ceramic cutter, according to claim 1, wherein the support structure is vertically aligned with a longitudinal median plane of the work table and with the longitudinal path of the cutting tool, and comprises at least one longitudinal profile arranged below said work table.

3. The ceramic cutter, according to claim 1, wherein the longitudinal guide comprises a first longitudinal track and a second longitudinal track along which vertical rolling elements and horizontal rolling elements move, which are connected to the sliding piece by means of respective rotating shafts; and which limit a movement of said sliding piece to only a longitudinal direction.

4. The ceramic cutter, according to claim 3, wherein the first track is defined on a lateral face of the longitudinal guide facing the tool-carrier head, and the second track is defined on a lower face of said longitudinal guide.

5. The cutter, according to claim 4, wherein the sliding piece comprises a vertical flange arranged between the longitudinal guide and the tool-carrier head, and a horizontal flange arranged between the lower face of the longitudinal guide and the work table.

6. The cutter, according to claim 5, wherein the rotating shafts of the vertical rolling elements that move along the first track of the longitudinal guide and the horizontal shaft for rotating the tool-carrier head are mounted on the vertical flange of the sliding piece.

7. The cutter, according to claim 5, wherein the rotating shafts of the horizontal rolling elements that move along the second track of the longitudinal guide are mounted on the horizontal flange of the sliding piece.
